(19) United States
(12) Patent Application Publication
(10) Pub. No.: US 2014/0301181 A1
(43) Pub. Date: Oct. 9, 2014

(54) DETECTING, REPORTING, AND RECOVERING FROM POTENTIAL SERVICE DISRUPTIONS

(71) Applicant: QUALCOMM Incorporated, San Diego, CA (US)

(72) Inventors: Vijay Anandrao SURYAVANSHI, San Diego, CA (US); Mark Aaron LINDNER, Verona, WI (US); Daniel ABPLANALP, Salem, OR (US); Saritha SIVAPURAM, San Diego, CA (US)

(73) Assignee: QUALCOMM Incorporated, San Diego, CA (US)

(21) Appl. No.: 14/230,383

(22) Filed: Mar. 31, 2014

Related U.S. Application Data
(60) Provisional application No. 61/807,933, filed on Apr. 3, 2013.

(51) Int. Cl. H04L 12/24

(52) U.S. Cl. CPC H04L 41/0654
USPC 370/218

(57) ABSTRACT

A user equipment (UE) detects a change in one or more criteria, determines whether a severity of the potential loss of network service is above a severity threshold, transmits a ping to a server to which the UE was connected before detecting the potential loss of network service based on the severity of the potential loss of network service being above the severity threshold, and blocks transmission of a ping to the server based on the severity of the potential loss of network service not being above the severity threshold. A server attempts unsuccessfully to connect received call requests to the UE, transmits one or more pings to the UE, and changes a presence status of the UE to indicate that the UE is likely not reachable based on not receiving a response to the one or more pings from the UE before transmitting a threshold number of pings.

### CROSS-REFERENCE TO RELATED APPLICATIONS

The present application for patent claims the benefit of U.S. Provisional Application No. 61/807,933, entitled “DETECTING, REPORTING, AND RECOVERING FROM POTENTIAL SERVICE DISRUPTIONS,” filed Apr. 3, 2013, assigned to the assignee hereof, and expressly incorporated herein by reference in their entirety.

### BACKGROUND OF THE INVENTION

1. Field of the Disclosure

The various aspects of the disclosure are directed to detecting, reporting, and recovering from potential service disruptions.

2. Description of the Related Art

Wireless communication systems have developed through various generations, including a first-generation analog wireless phone service (1G), a second-generation (2G) digital wireless phone service (including interim 2.5G and 2.75G networks) and third-generation (3G) and fourth-generation (4G) high speed data/Internet-capable wireless services. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

More recently, Long Term Evolution (LTE) has been developed as a wireless communications protocol for wireless communication of high-speed data for mobile phones and other data terminals. LTE is based on GSM, and includes contributions from various GSM-related protocols such as Enhanced Data rates for GSM Evolution (EDGE), and Universal Mobile Telecommunications System (UMTS) protocols such as High-Speed Packet Access (HSPA).

User equipments (UEs) may occasionally lose network service, or connectivity, with the RAN (e.g., RAN 120) or another access point (e.g., access point 125), such as when the UE is in an underground subway system, in an elevator, going through a tunnel, or the like. When the UE regains connectivity, it assumes that all of the network connections between itself and the server (e.g., application server 170) recovered correctly. However, that is not always the case, and the UE may not discover the problem until the user attempts to make a call, or the UE attempts to perform some other network interaction. At that time, the UE may have to re-register with the network, causing a delay.

### SUMMARY

An aspect of the disclosure is directed to detecting a potential loss of network service performed by a user equipment (UE). A method for detecting a potential loss of network service performed by a UE includes detecting a change in one or more criteria, the change in the one or more criteria indicating a potential loss of network service, determining whether or not a severity of the potential loss of network service is above a severity threshold based on the change in the one or more criteria, transmitting a ping to a server to which the UE was connected before detecting the potential loss of network service based on the severity of the potential loss of network service being above the severity threshold, and blocking transmission of a ping to the server to which the UE was connected before detecting the potential loss of network service based on the severity of the potential loss of network service not being above the severity threshold.

An apparatus for detecting a potential loss of network service performed by a UE includes logic configured to detect a change in one or more criteria, the change in the one or more criteria indicating a potential loss of network service, logic configured to determine whether or not a severity of the potential loss of network service is above a severity threshold based on the change in the one or more criteria, logic configured to transmit a ping to a server to which the UE was connected before detecting the potential loss of network service based on the severity of the potential loss of network service being above the severity threshold, and logic configured to block transmission of a ping to the server to which the UE was connected before detecting the potential loss of network service based on the severity of the potential loss of network service not being above the severity threshold.

An apparatus for detecting a potential loss of network service performed by a UE includes means for detecting a change in one or more criteria, the change in the one or more criteria indicating a potential loss of network service, means for determining whether or not a severity of the potential loss of network service is above a severity threshold based on the change in the one or more criteria, means for transmitting a ping to a server to which the UE was connected before detecting the potential loss of network service based on the severity of the potential loss of network service being above the severity threshold, and means for blocking transmission of a ping to the server to which the UE was connected before detecting the potential loss of network service based on the severity of the potential loss of network service not being above the severity threshold.

A non-transitory computer-readable medium for detecting a potential loss of network service performed by a UE includes at least one instruction to detect a change in one or more criteria, the change in the one or more criteria indicating a potential loss of network service, at least one instruction to determine whether or not a severity of the potential loss of network service is above a severity threshold based on the change in the one or more criteria, at least one instruction to transmit a ping to a server to which the UE was connected before detecting the potential loss of network service based on the severity of the potential loss of network service being above the severity threshold, and at least one instruction to block transmission of a ping to the server to which the UE was connected before detecting the potential loss of network service based on the severity of the potential loss of network service not being above the severity threshold.

An aspect of the disclosure is directed to regaining a connection to a UE performed by a server. A method for regaining a connection to a UE performed by a server includes attempting unsuccessfully to connect one or more received call requests to the UE, transmitting one or more pings to the UE, and changing a presence status of the UE to indicate that the UE is likely not reachable based on not receiving a response to the one or more pings from the UE before the server transmits a threshold number of pings to the UE.

An apparatus for regaining a connection to a UE performed by a server includes logic configured to attempt unsuccessfully to connect one or more received call requests to the UE, logic configured to transmit one or more pings to the UE, and logic configured to change a presence status of the UE to indicate that the UE is likely not reachable based on not receiving a response to the one or more pings from the UE before the server transmits a threshold number of pings to the UE.

An apparatus for regaining a connection to a UE performed by a server includes means for attempting unsuccessfully to connect one or more received call requests to the UE, means for transmitting one or more pings to the UE, and means for changing a presence status of the UE to indicate that the UE is likely not reachable based on not receiving a response to the one or more pings from the UE before the server transmits a threshold number of pings to the UE.

A non-transitory computer-readable medium for regaining a connection to a UE performed by a server includes at least one instruction to attempt unsuccessfully to connect one or more received call requests to the UE, at least one instruction to transmit one or more pings to the UE, and at least one instruction to change a presence status of the UE to indicate that the UE is likely not reachable based on not receiving a response to the one or more pings from the UE before the server transmits a threshold number of pings to the UE.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates a high-level system architecture of a wireless communications system in accordance with an aspect of the disclosure.

FIG. 2A illustrates an example configuration of a radio access network (RAN) and a packet-switched portion of a core network for a 1x EV-DO network in accordance with an aspect of the disclosure.

FIG. 2B illustrates an example configuration of the RAN and a packet-switched portion of a General Packet Radio Service (GPRS) core network within a 3G UMTS W-CDMA system in accordance with an aspect of the disclosure.

FIG. 2C illustrates another example configuration of the RAN and a packet-switched portion of a GPRS core network within a 3G UMTS W-CDMA system in accordance with an aspect of the disclosure.

FIG. 2D illustrates an example configuration of the RAN and a packet-switched portion of the core network that is based on an Evolved Packet System (EPS) or Long Term Evolution (LTE) network in accordance with an aspect of the disclosure.

FIG. 2E illustrates an example configuration of an enhanced High Rate Packet Data (HRPD) RAN connected to an EPS or LTE network and also a packet-switched portion of an HRPD core network in accordance with an aspect of the disclosure.

FIG. 3 illustrates examples of user equipments (UEs) in accordance with aspects of the disclosure.

FIG. 4 illustrates a communication device that includes logic configured to perform functionality in accordance with an aspect of the disclosure.

FIG. 5 illustrates an exemplary server according to various aspects of the disclosure.

FIG. 6 illustrates a high-level flow of a conventional registration sequence.

FIG. 7 illustrates an exemplary flow for detecting potential service disruptions at a UE.

FIG. 8 illustrates an exemplary flow for detecting potential service disruptions performed at a UE.

FIG. 9 illustrates an exemplary flow of actions the application server can perform to regain a connection to a UE.

FIG. 10 illustrates an exemplary flow for detecting potential service disruptions affecting a UE.

FIG. 11 illustrates an exemplary flow for determining the rate at which the application server may ping the UE.

### DETAILED DESCRIPTION

Various aspects are disclosed in the following description and related drawings. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

A client device, referred to herein as a user equipment (UE), may be mobile or stationary, and may communicate with a radio access network (RAN). As used herein, the term “UE” may be referred to interchangeably as an “access terminal” or “AT,” a “wireless device,” a “subscriber device,” a “subscriber terminal,” a “subscriber station,” a “user terminal” or UT, a “mobile terminal,” a “mobile station” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

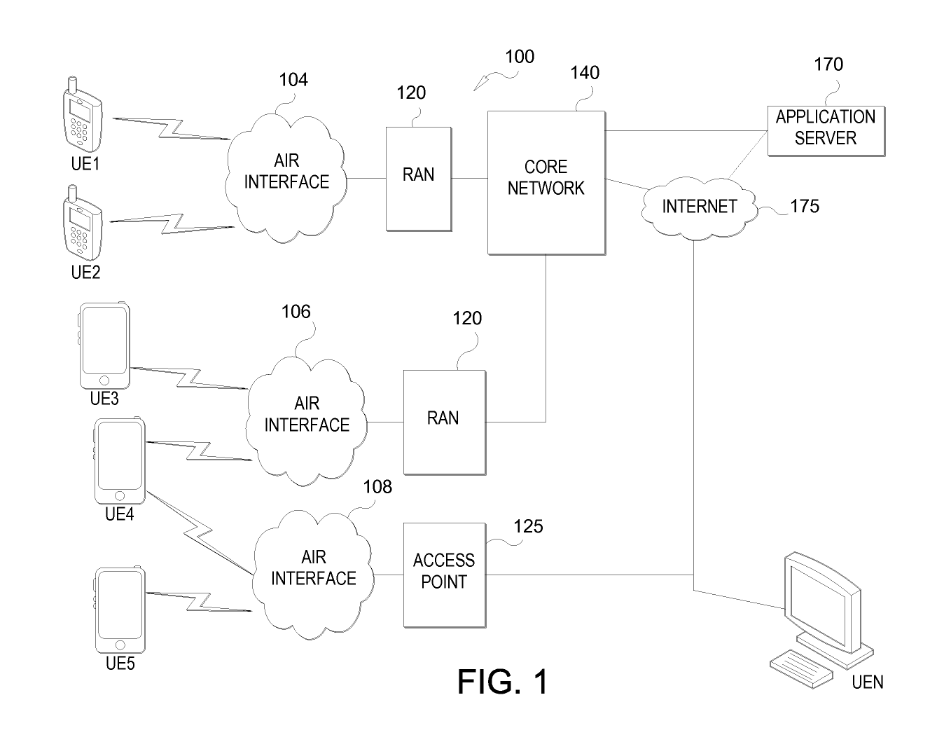

FIG. 1 illustrates a high-level system architecture of a wireless communications system 100 in accordance with an aspect of the disclosure. The wireless communications system 100 contains UEs 1 . . . N. The UEs 1 . . . N can include cellular telephones, personal digital assistant (PDAs), pagers, a laptop computer, a desktop computer, and so on. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., the RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., Code Division Multiple Access (CDMA), Evolution-Data Optimized (EV-DO), Evolved High Rate Packet Data (eHRPD), Global System of Mobile Communication (GSM), Enhanced Data rates for GSM Evolution (EDGE), Wideband CDMA (W-CDMA), Long-Term Evolution (LTE), etc.), while the air interface 108 can comply with a wireless IP protocol (e.g., IEEE 802.11). The RAN 120 includes a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UE N and UEs 1 . . . N via the core network 140. Also shown in FIG. 1 is the access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, an application server 170 is shown as connected to the Internet 175, the core network 140, or both. The application server 170 can be implemented as a plurality of structurally separate servers, or alternately may correspond to a single server. As will be described below in more detail, the application server 170 is configured to support one or more communication services (e.g., Voice-over-Internet Protocol (VoIP) sessions, Push-to-Talk (PTT) sessions, group communication sessions, social networking services, etc.) for UEs that can connect to the application server 170 via the core network 140 and/or the Internet 175.

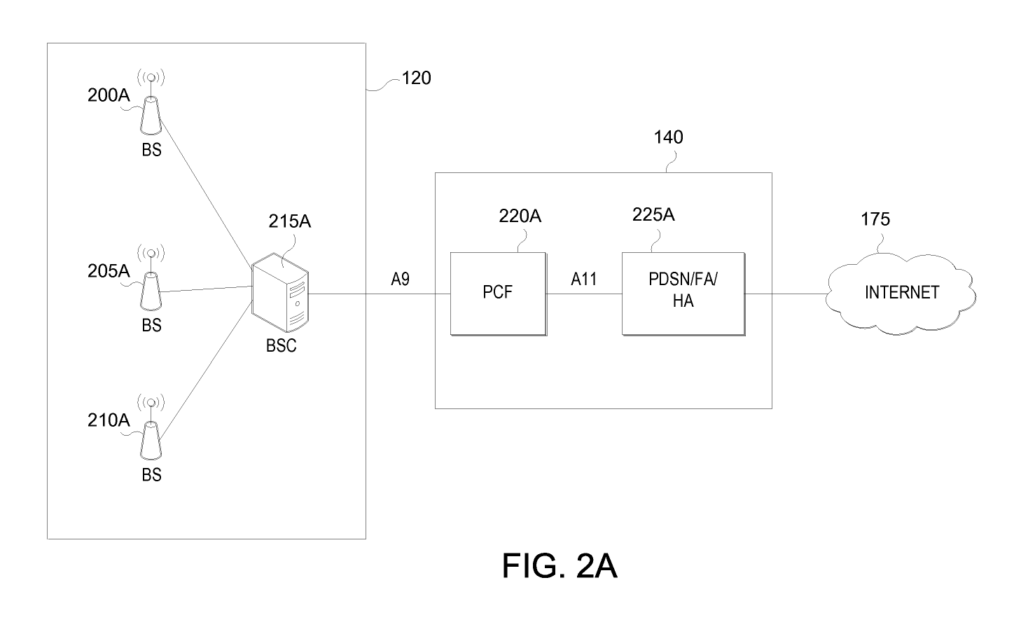

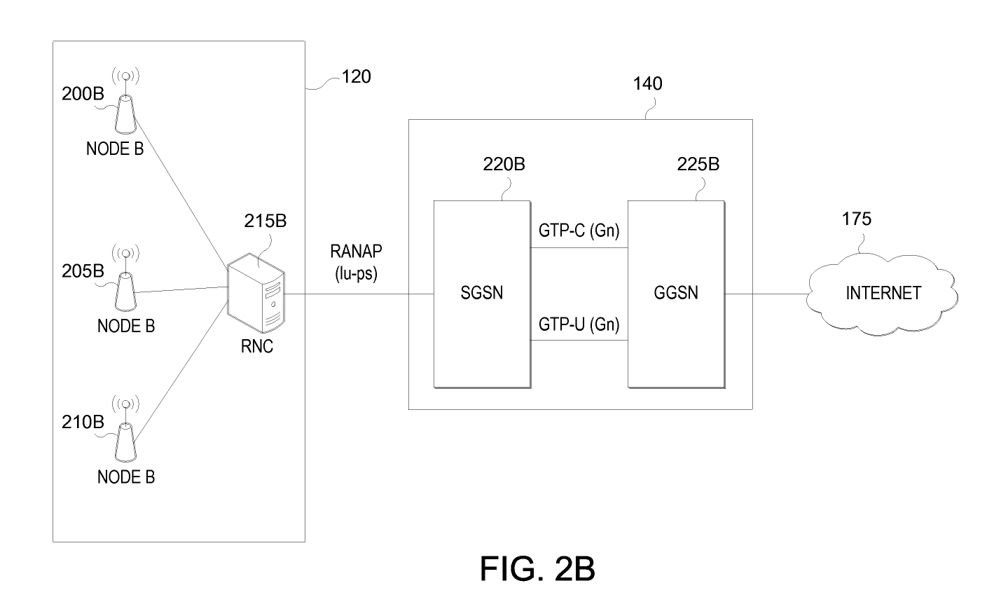

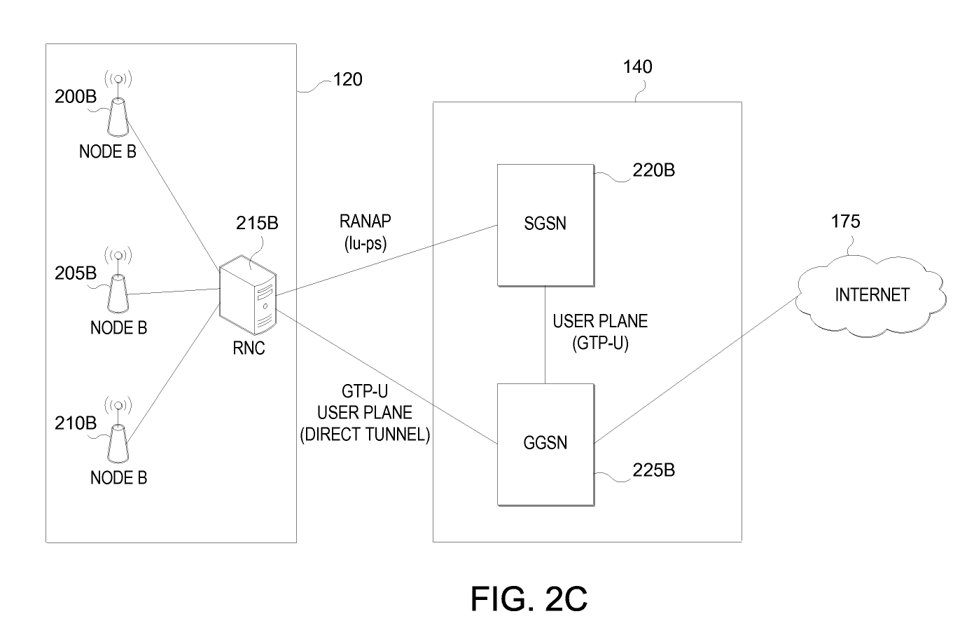

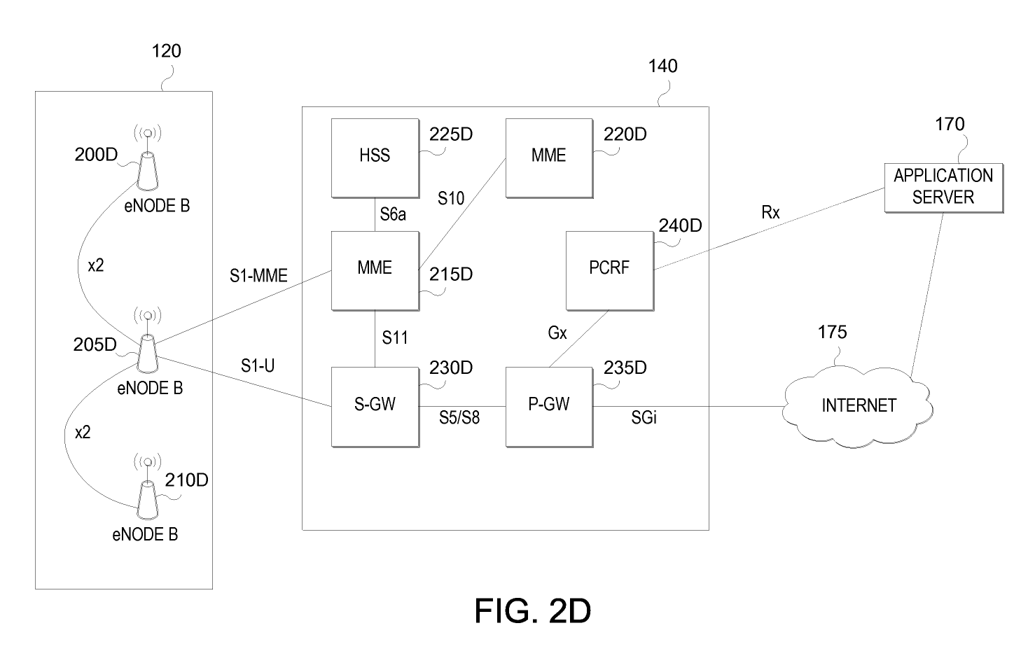

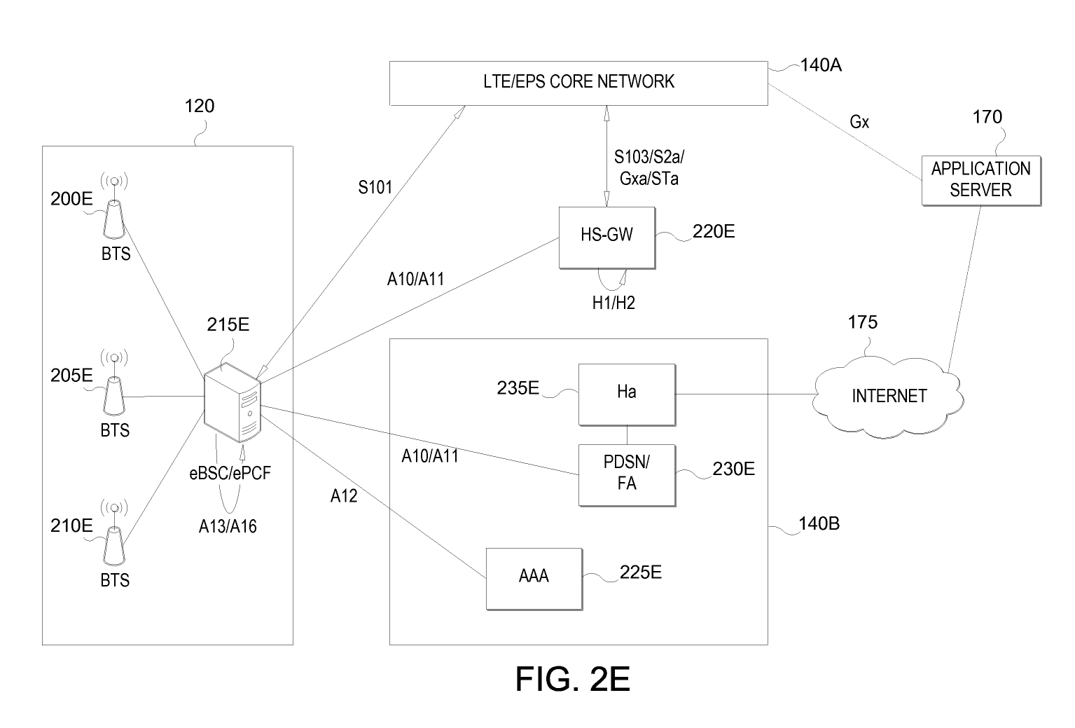

Examples of protocol-specific implementations for the RAN 120 and the core network 140 are provided below with respect to FIGS. 2A through 2D to help explain the wireless communications system 100 in more detail. In particular, the components of the RAN 120 and the core network 140 corresponds to components associated with supporting packet-switched (PS) communications, whereby legacy circuit-switched (CS) components may also be present in these networks, but any legacy CS-specific components are not shown explicitly in FIGS. 2A-2D.

FIG. 2A illustrates an example configuration of the RAN 120 and the core network 140 for packet-switched communications in a CDMA2000 1x Evolution-Data Optimized (EV-DO) network in accordance with an aspect of the disclosure. Referring to FIG. 2A, the RAN 120 includes a plurality of base stations (BSs) 200A, 205A and 210A that are coupled to a base station controller (BSC) 215A over a wired backhaul interface. A group of BSs controlled by a single BSC is collectively referred to as a subnet. As will be appreciated by one of ordinary skill in the art, the RAN 120 can include multiple BSCs and subnets, and a single BSC is shown in FIG. 2A for the sake of convenience. The BSC 215A communicates with a packet control function (PCF) 220A within the core network 140 over an A9 connection. The PCF 220A performs certain processing functions for the BSC 215A related to packet data. The PCF 220A communicates with a Packet Data Serving Node (PDSN) 225A within the core network 140 over an A11 connection. The PDSN 225A has a variety of functions, including managing Point-to-Point (PPP) sessions, acting as a home agent (HA) and/or foreign agent (FA), and is similar in function to a Gateway General Packet Radio Service (GPRS) Support Node (GGSN) in GSM and UMTS networks (described below in more detail). The PDSN 225A connects the core network 140 to external IP networks, such as the Internet 175.

FIG. 2B illustrates an example configuration of the RAN 120 and a packet-switched portion of the core network 140 that is configured as a GPRS core network within a 3G UMTS W-CDMA system in accordance with an aspect of the disclosure. Referring to FIG. 2B, the RAN 120 includes a plurality of Node Bs 200B, 205B and 210B that are coupled to a Radio Network Controller (RNC) 215B over a wired backhaul interface. Similar to 1x EV-DO networks, a group of Node Bs controlled by a single RNC is collectively referred to as a subnet. As will be appreciated by one of ordinary skill in the art, the RAN 120 can include multiple RNCs and subnets, and a single RNC is shown in FIG. 2B for the sake of convenience. The RNC 215B is responsible for signaling, establishing and tearing down bearer channels (i.e., data channels) between a Serving GRPS Support Node (SGSN) 220B in the core network 140 and UEs served by the RAN 120. If link layer encryption is enabled, the RNC 215B also encrypts the content before forwarding it to the RAN 120 for transmission over an air interface. The function of the RNC 215B is well-known in the art and will not be discussed further for the sake of brevity.

In FIG. 2B, the core network 140 includes the above-noted SGSN 220B (and potentially a number of other SGSNs as well) and a GGSN 225B. Generally, GPRS is a protocol used in GSM for routing IP packets. The GPRS core network (e.g., the GGSN 225B and one or more SGSNs 220B) is the centralized part of the GPRS system and also provides support for W-CDMA based 3G access networks. The GPRS core network is an integrated part of the GSM core network (i.e., the core network 140) that provides mobility management, session management and transport for IP packet services in GSM and W-CDMA networks.

The GPRS Tunneling Protocol (GTP) is the defining IP protocol of the GPRS core network. The GTP is the protocol which allows end users (e.g., UEs) of a GSM or W-CDMA network to move from place to place while continuing to connect to the Internet 175 as if from one location at the GGSN 225B. This is achieved by transferring the respective UE's data from the UE's current SGSN 220B to the GGSN 225B, which is handling the respective UE's session.

Three forms of GTP are used by the GPRS core network; namely, (i) GTP-U, (ii) GTP-C and (iii) GTP′ (GTP Prime). GTP-U is used for transfer of user data in separated tunnels for each packet data protocol (PDP) context. GTP-C is used for control signaling (e.g., setup and deletion of PDP contexts, verification of GSN reach-ability, updates or modifications such as when a subscriber moves from one SGSN to another, etc.). GTP′ is used for transfer of charging data from GSNs to a charging function.

Referring to FIG. 2B, the GGSN 225B acts as an interface between a GPRS backbone network (not shown) and the Internet 175. The GGSN 225B extracts packet data with associated a packet data protocol (PDP) format (e.g., IP or PPP) from GPRS packets coming from the SGSN 220B, and sends the packets out on a corresponding packet data network. In the other direction, the incoming data packets are directed by the GGSN connected UE to the SGSN 220B which manages and controls the Radio Access Bearer (RAB) of a target UE served by the RAN 120. Thereby, the GGSN 225B stores the current SGSN address of the target UE and its associated profile in a location register (e.g., within a PDP context). The GGSN 225B is responsible for IP address assignment and is the default router for a connected UE. The GGSN 225B also performs authentication and charging functions.

The SGSN 220B is representative of one of many SGSNs within the core network 140, in an example. Each SGSN is responsible for the delivery of data packets from and to the UEs within an associated geographical service area. The tasks of the SGSN 220B includes packet routing and transfer, mobility management (e.g., attach/detach and location management), logical link management, and authentication and charging functions. The location register of the SGSN 220B stores location information (e.g., current cell, current VLR) and user profiles (e.g., IMSI, PDP address(es) used in the packet data network) of all GPRS users registered with the SGSN 220B, for example, within one or more PDP contexts for each user or UE. Thus, SGSNs 220B are responsible for (i) de-tunneling downlink GTP packets from the GGSN 225B, (ii) uplink tunnel IP packets toward the GGSN 225B, (iii) carrying out mobility management as UEs move between SGSN service areas and (iv) billing mobile subscribers. As will be appreciated by one of ordinary skill in the art, aside from (i)-(iv), SGSNs configured for GSM/EDGE networks have slightly different functionality as compared to SGSNs configured for W-CDMA networks.

The RAN 120 (e.g., or UTRAN, in UMTS system architecture) communicates with the SGSN 220B via a Radio Access Network Application Part (RANAP) protocol. RANAP operates over a Iu interface (Iu-ps), with a transmission protocol such as Frame Relay or IP. The SGSN 220B communicates with the GGSN 225B via a Gn interface, which is an IP-based interface between SGSN 220B and other SGSNs (not shown) and internal GGSNs (not shown), and uses the GTP protocol defined above (e.g., GTP-U, GTP-C, GTP′, etc.). In the example of FIG. 2B, the Gn between the SGSN 220B and the GGSN 225B carries both the GTP-C and the GTP-U. While not shown in FIG. 2B, the Gn interface is also used by the Domain Name System (DNS). The GGSN 225B is connected to a Public Data Network (PDN) (not shown), and in turn to the Internet 175, via a Gi interface with IP protocols either directly or through a Wireless Application Protocol (WAP) gateway.

FIG. 2C illustrates another example configuration of the RAN 120 and a packet-switched portion of the core network 140 that is configured as a GPRS core network within a 3G UMTS W-CDMA system in accordance with an aspect of the disclosure. Similar to FIG. 2B, the core network 140 includes the SGSN 220B and the GGSN 225B. However, in FIG. 2C, Direct Tunnel is an optional function in Iu mode that allows the SGSN 220B to establish a direct user plane tunnel, GTP-U, between the RAN 120 and the GGSN 225B within a PS domain. A Direct Tunnel capable SGSN, such as SGSN 220B in FIG. 2C, can be configured on a per GGSN and per RNC basis whether or not the SGSN 220B can use a direct user plane connection. The SGSN 220B in FIG. 2C handles the control plane signaling and makes the decision of when to establish Direct Tunnel. When the RAB assigned for a PDP context is released (i.e. the PDP context is preserved) the GTP-U tunnel is established between the GGSN 225B and SGSN 220B in order to be able to handle the downlink packets.

FIG. 2D illustrates an example configuration of the RAN 120 and a packet-switched portion of the core network 140 based on an Evolved Packet System (EPS) or LTE network, in accordance with an aspect of the disclosure. Referring to FIG. 2D, unlike the RAN 120 shown in FIGS. 2B-2C, the RAN 120 in the EPS/LTE network is configured with a plurality of Evolved Node Bs (ENodeBs or eNBs) 200D, 205D and 210D, without the RNC 215B from FIGS. 2B-2C. This is because ENodeBs in EPS/LTE networks do not require a separate controller (i.e., the RNC 215B) within the RAN 120 to communicate with the core network 140. In other words, some of the functionality of the RNC 215B from FIGS. 2B-2C is built into each respective eNodeB of the RAN 120 in FIG. 2D.

In FIG. 2D, the core network 140 includes a plurality of Mobility Management Entities (MMEs) 215D and 220D, a Home Subscriber Server (HSS) 225D, a Serving Gateway (S-GW) 230D, a Packet Data Network Gateway (P-GW) 235D and a Policy and Charging Rules Function (PCRF) 240D. Network interfaces between these components, the RAN 120 and the Internet 175 are illustrated in FIG. 2D and are defined in Table 1 (below) as follows:

TABLE 1
EPS/LTE Core Network Connection Definitions

| Network Interface | Description |
|---|---|
| S1-MME | Reference point for the control plane protocol between RAN 120 and |
| | MME 215D. |
| S1-U | Reference point between RAN 120 and S-GW 230D for the per |
| | bearer user plane tunneling and inter-eNodeB path switching during |
| | handover. |
| S5 | Provides user plane tunneling and tunnel management between S- |
| | GW 230D and P-GW 235D. It is used for S-GW relocation due to |
| | UE mobility and if the S-GW 230D needs to connect to a non- |
| | collocated P-GW for the required PDN connectivity. |
| S6a | Enables transfer of subscription and authentication data for |
| | authenticating/authorizing user access to the evolved system |
| | (Authentication, Authorization, and Accounting [AAA] interface) |
| | between MME 215D and HSS 225D. |
| Gx | Provides transfer of Quality of Service (QoS) policy and charging |
| | rules from PCRF 240D to Policy a Charging Enforcement Function |
| | (PCEF) component (not shown) in the P-GW 235D. |
| S8 | Inter-PLMN reference point providing user and control plane |
| | between the S-GW 230D in a Visited Public Land Mobile Network |
| | (VPLMN) and the P-GW 235D in a Home Public Land Mobile |
| | Network (HPLMN). S8 is the inter-PLMN variant of S5. |
| S10 | Reference point between MMEs 215D and 220D for MME |
| | relocation and MME to MME information transfer. |
| S11 | Reference point between MME 215D and S-GW 230D. |
| SGi | Reference point between the P-GW 235D and the packet data |
| | network, shown in FIG. 2D as the Internet 175. The Packet data |
| | network may be an operator external public or private packet data |
| | network or an intra-operator packet data network (e.g., for provision |
| | of IMS services). This reference point corresponds to Gi for 3GPP |
| | accesses. |
| X2 | Reference point between two different eNodeBs used for UE |
| | handoffs. |
| Rx | Reference point between the PCRF 240D and an application function |
| | (AF) that is used to exchanged application-level session information, |
| | where the AF is represented in FIG. 1 by the application server 170. |

A high-level description of the components shown in the RAN 120 and core network 140 of FIG. 2D will now be described. However, these components are each well-known in the art from various 3GPP TS standards, and the description contained herein is not intended to be an exhaustive description of all functionalities performed by these components.

Referring to FIG. 2D, the MMEs 215D and 220D are configured to manage the control plane signaling for the EPS bearers. MME functions include: Non-Access Stratum (NAS) signaling, NAS signaling security, Mobility management for inter- and intra-technology handovers, P-GW and S-GW selection, and MME selection for handovers with MME change.

Referring to FIG. 2D, the S-GW 230D is the gateway that terminates the interface toward the RAN 120. For each UE associated with the core network 140 for an EPS-based system, at a given point of time, there is a single S-GW. The functions of the S-GW 230D, for both the GTP-based and the Proxy Mobile IPv6 (PMIP)-based S5/S8, include: Mobility anchor point, Packet routing and forwarding, and setting the DiffSery Code Point (DSCP) based on a QoS Class Identifier (QCI) of the associated EPS bearer.

Referring to FIG. 2D, the P-GW 235D is the gateway that terminates the SGi interface toward the Packet Data Network (PDN), e.g., the Internet 175. If a UE is accessing multiple PDNs, there may be more than one P-GW for that UE; however, a mix of S5/S8 connectivity and Gn/Gp connectivity is not typically supported for that UE simultaneously. P-GW functions include for both the GTP-based S5/S8: Packet filtering (by deep packet inspection), UE IP address allocation, setting the DSCP based on the QCI of the associated EPS bearer, accounting for inter operator charging, uplink (UL) and downlink (DL) bearer binding as defined in 3GPP TS 23.203, UL bearer binding verification as defined in 3GPP TS 23.203. The P-GW 235D provides PDN connectivity to both GSM/EDGE Radio Access Network (GERAN)/UTRAN only UEs and E-UTRAN-capable UEs using any of E-UTRAN, GERAN, or UTRAN. The P-GW 235D provides PDN connectivity to E-UTRAN capable UEs using E-UTRAN only over the S5/S8 interface.

Referring to FIG. 2D, the PCRF 240D is the policy and charging control element of the EPS-based core network 140. In a non-roaming scenario, there is a single PCRF in the HPLMN associated with a UE's Internet Protocol Connectivity Access Network (IP-CAN) session. The PCRF terminates the Rx interface and the Gx interface. In a roaming scenario with local breakout of traffic, there may be two PCRFs associated with a UE's IP-CAN session: A Home PCRF (H-PCRF) is a PCRF that resides within a HPLMN, and a Visited PCRF (V-PCRF) is a PCRF that resides within a visited VPLMN. PCRF is described in more detail in 3GPP TS 23.203, and as such will not be described further for the sake of brevity. In FIG. 2D, the application server 170 (e.g., which can be referred to as the AF in 3GPP terminology) is shown as connected to the core network 140 via the Internet 175, or alternatively to the PCRF 240D directly via an Rx interface. Generally, the application server 170 (or AF) is an element offering applications that use IP bearer resources with the core network (e.g. UMTS PS domain/GPRS domain resources/LTE PS data services). One example of an application function is the Proxy-Call Session Control Function (P-CSCF) of the IP Multimedia Subsystem (IMS) Core Network sub system. The AF uses the Rx reference point to provide session information to the PCRF 240D. Any other application server offering IP data services over cellular network can also be connected to the PCRF 240D via the Rx reference point.

FIG. 2E illustrates an example of the RAN 120 configured as an enhanced High Rate Packet Data (HRPD) RAN connected to an EPS or LTE network 140A and also a packet-switched portion of an HRPD core network 140B in accordance with an aspect of the disclosure. The core network 140A is an EPS or LTE core network, similar to the core network described above with respect to FIG. 2D.

In FIG. 2E, the eHRPD RAN includes a plurality of base transceiver stations (BTSs) 200E, 205E and 210E, which are connected to an enhanced BSC (eBSC) and enhanced PCF (ePCF) 215E. The eBSC/ePCF 215E can connect to one of the MMEs 215D or 220D within the EPS core network 140A over an S101 interface, and to an HRPD serving gateway (HSGW) 220E over A10 and/or A11 interfaces for interfacing with other entities in the EPS core network 140A (e.g., the S-GW 230D over an S103 interface, the P-GW 235D over an S2a interface, the PCRF 240D over a Gxa interface, a 3GPP AAA server (not shown explicitly in FIG. 2D) over an STa interface, etc.). The HSGW 220E is defined in 3GPP2 to provide the interworking between HRPD networks and EPS/LTE networks. As will be appreciated, the eHRPD RAN and the HSGW 220E are configured with interface functionality to EPC/LTE networks that is not available in legacy HRPD networks.

Turning back to the eHRPD RAN, in addition to interfacing with the EPS/LTE network 140A, the eHRPD RAN can also interface with legacy HRPD networks such as HRPD network 140B. As will be appreciated the HRPD network 140B is an example implementation of a legacy HRPD network, such as the EV-DO network from FIG. 2A. For example, the eBSC/ePCF 215E can interface with an authentication, authorization and accounting (AAA) server 225E via an A12 interface, or to a PDSN/FA 230E via an A10 or A11 interface. The PDSN/FA 230E in turn connects to HA 235A, through which the Internet 175 can be accessed. In FIG. 2E, certain interfaces (e.g., A13, A16, H1, H2, etc.) are not described explicitly but are shown for completeness and would be understood by one of ordinary skill in the art familiar with HRPD or eHRPD.

Referring to FIGS. 2B-2E, it will be appreciated that LTE core networks (e.g., FIG. 2D) and HRPD core networks that interface with eHRPD RANs and HSGWs (e.g., FIG. 2E) can support network-initiated Quality of Service (QoS) (e.g., by the P-GW, GGSN, SGSN, etc.) in certain cases.

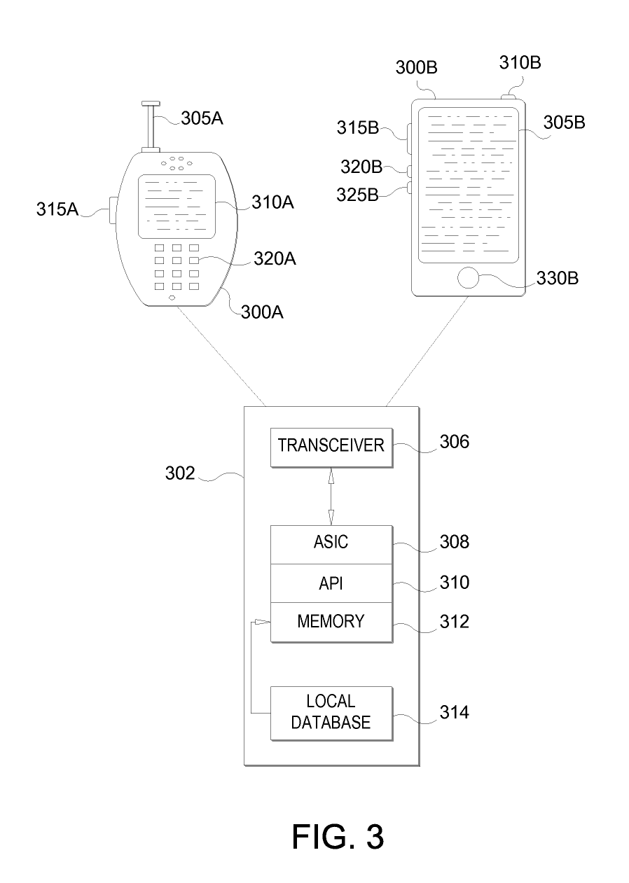

FIG. 3 illustrates examples of UEs in accordance with aspects of the disclosure. Referring to FIG. 3, UE 300A is illustrated as a calling telephone and UE 300B is illustrated as a touchscreen device (e.g., a smart phone, a tablet computer, etc.). As shown in FIG. 3, an external casing of UE 300A is configured with an antenna 305A, display 310A, at least one button 315A (e.g., a PTT button, a power button, a volume control button, etc.) and a keypad 320A among other components, as is known in the art. Also, an external casing of UE 300B is configured with a touchscreen display 305B, peripheral buttons 310B, 315B, 320B and 325B (e.g., a power control button, a volume or vibrate control button, an airplane mode toggle button, etc.), at least one front-panel button 330B (e.g., a Home button, etc.), among other components, as is known in the art. While not shown explicitly as part of UE 300B, the UE 300B can include one or more external antennas and/or one or more integrated antennas that are built into the external casing of UE 300B, including but not limited to WiFi antennas, cellular antennas, satellite position system (SPS) antennas (e.g., global positioning system (GPS) antennas), and so on.

While internal components of UEs such as the UEs 300A and 300B can be embodied with different hardware configurations, a basic high-level UE configuration for internal hardware components is shown as platform 302 in FIG. 3. The platform 302 can receive and execute software applications, data and/or commands transmitted from the RAN 120 that may ultimately come from the core network 140, the Internet 175 and/or other remote servers and networks (e.g., application server 170, web URLs, etc.). The platform 302 can also independently execute locally stored applications without RAN interaction. The platform 302 can include a transceiver 306 operably coupled to an application specific integrated circuit (ASIC) 308, or other processor, microprocessor, logic circuit, or other data processing device. The ASIC 308 or other processor executes the application programming interface (API) 310 layer that interfaces with any resident programs in the memory 312 of the wireless device. The memory 312 can be comprised of read-only memory (ROM) or random-access memory (RAM), electrically erasable programmable ROM (EEPROM), flash cards, or any memory common to computer platforms. The platform 302 also can include a local database 314 that can store applications not actively used in memory 312, as well as other data. The local database 314 is typically a flash memory cell, but can be any secondary storage device as known in the art, such as magnetic media, EEPROM, optical media, tape, soft or hard disk, or the like.

Accordingly, an aspect of the disclosure can include a UE (e.g., UE 300A, 300B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 308, memory 312, API 310 and local database 314 may all be used cooperatively to load, store and execute the various functions disclosed herein and thus the logic to perform these functions may be distributed over various elements. Alternatively, the functionality could be incorporated into one discrete component. Therefore, the features of the UEs 300A and 300B in FIG. 3 are to be considered merely illustrative and the disclosure is not limited to the illustrated features or arrangement.

The wireless communication between the UEs 300A and/or 300B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs from the RAN using a variety of networks and configurations. Accordingly, the illustrations provided herein are not intended to limit the aspects of the disclosure and are merely to aid in the description of various aspects of the disclosure.

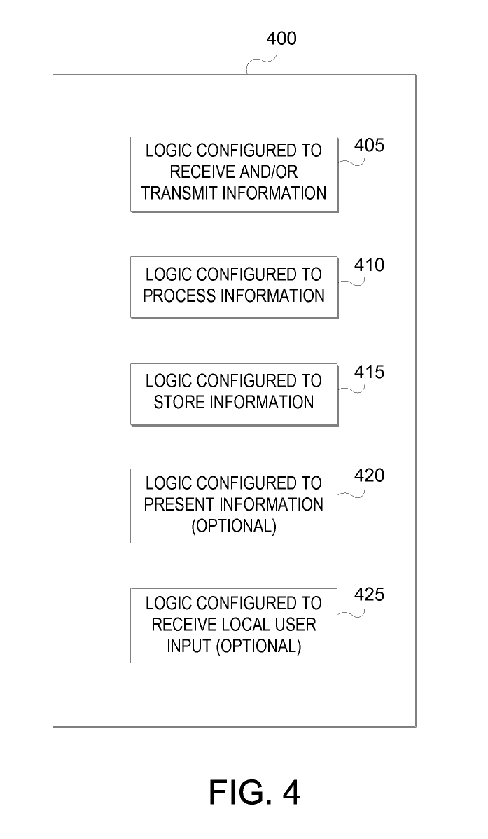

FIG. 4 illustrates a communication device 400 that includes logic configured to perform functionality. The communication device 400 can correspond to any of the above-noted communication devices, including but not limited to UEs 300A or 300B, any component of the RAN 120 (e.g., BSs 200A through 210A, BSC 215A, Node Bs 200B through 210B, RNC 215B, eNodeBs 200D through 210D, etc.), any component of the core network 140 (e.g., PCF 220A, PDSN 225A, SGSN 220B, GGSN 225B, MME 215D or 220D, HSS 225D, S-GW 230D, P-GW 235D, PCRF 240D), any components coupled with the core network 140 and/or the Internet 175 (e.g., the application server 170), and so on. Thus, communication device 400 can correspond to any electronic device that is configured to communicate with (or facilitate communication with) one or more other entities over the wireless communications system 100 of FIG. 1.

Referring to FIG. 4, the communication device 400 includes logic configured to receive and/or transmit information 405. In an example, if the communication device 400 corresponds to a wireless communications device (e.g., UE 300A or 300B, one of BSs 200A through 210A, one of Node Bs 200B through 210B, one of eNodeBs 200D through 210D, etc.), the logic configured to receive and/or transmit information 405 can include a wireless communications interface (e.g., Bluetooth, WiFi, 2G, CDMA, W-CDMA, 3G, 4G, LTE, etc.) such as a wireless transceiver and associated hardware (e.g., an RF antenna, a MODEM, a modulator and/or demodulator, etc.). Where the communication device 400 corresponds to an apparatus for detecting a potential loss of network service, the logic configured to receive and/or transmit information 405 may include logic configured to detect a change in one or more criteria, the change in the one or more criteria indicating a potential loss of network service, logic configured to transmit a ping to a server to which the UE was connected before detecting the potential loss of network service based on the severity of the potential loss of network service being above a severity threshold, and logic configured to block transmission of a ping to the server to which the UE was connected before detecting the potential loss of network service based on the severity of the potential loss of network service not being above the severity threshold. In another example, the logic configured to receive and/or transmit information 405 can correspond to a wired communications interface (e.g., a serial connection, a USB or Firewire connection, an Ethernet connection through which the Internet 175 can be accessed, etc.). Thus, if the communication device 400 corresponds to some type of network-based server (e.g., PDSN, SGSN, GGSN, S-GW, P-GW, MME, HSS, PCRF, the application server 170, etc.), the logic configured to receive and/or transmit information 405 can correspond to an Ethernet card, in an example, that connects the network-based server to other communication entities via an Ethernet protocol. Where the communication device 400 corresponds to an apparatus for regaining a connection to a UE, the logic configured to receive and/or transmit information 405 may include logic configured to attempt unsuccessfully to connect one or more received call requests to the UE, logic configured to transmit one or more pings to the UE, and logic configured to change a presence status of the UE to indicate that the UE is likely not reachable based on not receiving a response to the one or more pings from the UE before the server transmits a threshold number of pings to the UE. In a further example, the logic configured to receive and/or transmit information 405 can include sensory or measurement hardware by which the communication device 400 can monitor its local environment (e.g., an accelerometer, a temperature sensor, a light sensor, an antenna for monitoring local RF signals, etc.). The logic configured to receive and/or transmit information 405 can also include software that, when executed, permits the associated hardware of the logic configured to receive and/or transmit information 405 to perform its reception and/or transmission function(s). However, the logic configured to receive and/or transmit information 405 does not correspond to software alone, and the logic configured to receive and/or transmit information 405 relies at least in part upon hardware to achieve its functionality.

Referring to FIG. 4, the communication device 400 further includes logic configured to process information 410. In an example, the logic configured to process information 410 can include at least a processor. Example implementations of the type of processing that can be performed by the logic configured to process information 410 includes but is not limited to performing determinations, establishing connections, making selections between different information options, performing evaluations related to data, interacting with sensors coupled to the communication device 400 to perform measurement operations, converting information from one format to another (e.g., between different protocols such as .wmv to .avi, etc.), and so on. For example, where the communication device 400 corresponds to an apparatus for detecting a potential loss of network service, the logic configured to process information 410 may include logic configured to detect a change in one or more criteria, the change in the one or more criteria indicating a potential loss of network service, logic configured to determine whether or not a severity of the potential loss of network service is above a severity threshold based on the change in the one or more criteria, and logic configured to block transmission of a ping to the server to which the UE was connected before detecting the potential loss of network service based on the severity of the potential loss of network service not being above the severity threshold. Where the communication device 400 corresponds to an apparatus for regaining a connection to a UE, the logic configured to process information 410 may include logic configured to attempt unsuccessfully to connect one or more received call requests to the UE and logic configured to change a presence status of the UE to indicate that the UE is likely not reachable based on not receiving a response to the one or more pings from the UE before the server transmits a threshold number of pings to the UE. The processor included in the logic configured to process information 410 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 410 can also include software that, when executed, permits the associated hardware of the logic configured to process information 410 to perform its processing function(s). However, the logic configured to process information 410 does not correspond to software alone, and the logic configured to process information 410 relies at least in part upon hardware to achieve its functionality.

Referring to FIG. 4, the communication device 400 further includes logic configured to store information 415. In an example, the logic configured to store information 415 can include at least a non-transitory memory and associated hardware (e.g., a memory controller, etc.). For example, the non-transitory memory included in the logic configured to store information 415 can correspond to RAM, flash memory, ROM, erasable programmable ROM (EPROM), EEPROM, registers, hard disk, a removable disk, a CD-ROM, or any other form of storage medium known in the art. The logic configured to store information 415 can also include software that, when executed, permits the associated hardware of the logic configured to store information 415 to perform its storage function(s). However, the logic configured to store information 415 does not correspond to software alone, and the logic configured to store information 415 relies at least in part upon hardware to achieve its functionality.

Referring to FIG. 4, the communication device 400 further optionally includes logic configured to present information 420. In an example, the logic configured to present information 420 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 400. For example, if the communication device 400 corresponds to UE 300A or UE 300B as shown in FIG. 3, the logic configured to present information 420 can include the display 310A of UE 300A or the touchscreen display 305B of UE 300B. In a further example, the logic configured to present information 420 can be omitted for certain communication devices, such as network communication devices that do not have a local user (e.g., network switches or routers, remote servers, etc.). The logic configured to present information 420 can also include software that, when executed, permits the associated hardware of the logic configured to present information 420 to perform its presentation function(s). However, the logic configured to present information 420 does not correspond to software alone, and the logic configured to present information 420 relies at least in part upon hardware to achieve its functionality.

Referring to FIG. 4, the communication device 400 further optionally includes logic configured to receive local user input 425. In an example, the logic configured to receive local user input 425 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 400. For example, if the communication device 400 corresponds to UE 300A or UE 300B as shown in FIG. 3, the logic configured to receive local user input 425 can include the keypad 320A, any of the buttons 315A or 310B through 325B, the touchscreen display 305B, etc. In a further example, the logic configured to receive local user input 425 can be omitted for certain communication devices, such as network communication devices that do not have a local user (e.g., network switches or routers, remote servers, etc.). The logic configured to receive local user input 425 can also include software that, when executed, permits the associated hardware of the logic configured to receive local user input 425 to perform its input reception function(s). However, the logic configured to receive local user input 425 does not correspond to software alone, and the logic configured to receive local user input 425 relies at least in part upon hardware to achieve its functionality.

Referring to FIG. 4, while the configured logics of 405 through 425 are shown as separate or distinct blocks in FIG. 4, it will be appreciated that the hardware and/or software by which the respective configured logic performs its functionality can overlap in part. For example, any software used to facilitate the functionality of the configured logics of 405 through 425 can be stored in the non-transitory memory associated with the logic configured to store information 415, such that the configured logics of 405 through 425 each performs their functionality (i.e., in this case, software execution) based in part upon the operation of software stored by the logic configured to store information 415. Likewise, hardware that is directly associated with one of the configured logics can be borrowed or used by other configured logics from time to time. For example, the processor of the logic configured to process information 410 can format data into an appropriate format before being transmitted by the logic configured to receive and/or transmit information 405, such that the logic configured to receive and/or transmit information 405 performs its functionality (i.e., in this case, transmission of data) based in part upon the operation of hardware (i.e., the processor) associated with the logic configured to process information 410.

Generally, unless stated otherwise explicitly, the phrase “logic configured to” as used throughout this disclosure is intended to invoke an aspect that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the aspects described below in more detail.

Sessions that operate over networks such as 1x EV-DO in FIG. 2A, UMTS-based W-CDMA in FIGS. 2B-2C, LTE in FIG. 2D and eHRPD in FIG. 2E can be supported on channels (e.g. RABs, flows, etc.) for which a guaranteed quality level is reserved, which is referred to as Quality of Service (QoS). For example, establishing a given level of QoS on a particular channel may provide one or more of a minimum guaranteed bit rate (GBR) on that channel, a maximum delay, jitter, latency, bit error rate (BER), and so on. QoS resources can be reserved (or setup) for channels associated with real-time or streaming communication sessions, such as Voice-over IP (VoIP) sessions, group communication sessions (e.g., PTT sessions, etc.), online games, IP TV, and so on, to help ensure seamless end-to-end packet transfer for these sessions.

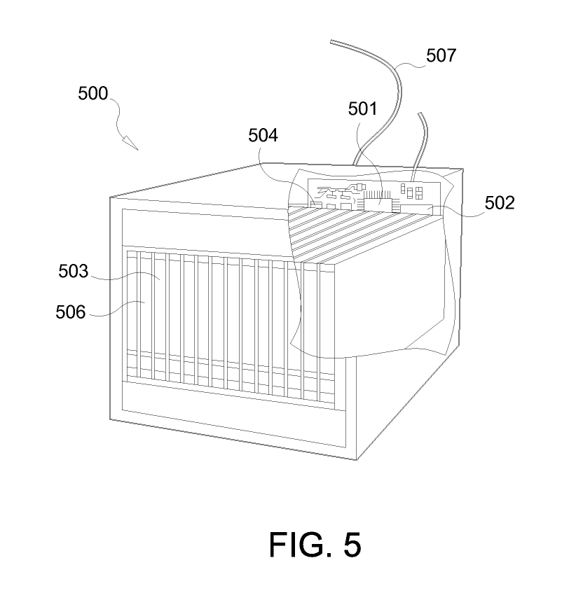

The various embodiments may be implemented on any of a variety of commercially available server devices, such as server 500 illustrated in FIG. 5. In an example, the server 500 may correspond to one example configuration of the application server 170 described above. In FIG. 5, the server 500 includes a processor 502 coupled to volatile memory 502 and a large capacity nonvolatile memory, such as a disk drive 503. The server 500 may also include a floppy disc drive, compact disc (CD) or DVD disc drive 506 coupled to the processor 501. The server 500 may also include network access ports 504 coupled to the processor 501 for establishing data connections with a network 507, such as a local area network coupled to other broadcast system computers and servers or to the Internet. In context with FIG. 4, it will be appreciated that the server 500 of FIG. 5 illustrates one example implementation of the communication device 400, whereby the logic configured to transmit and/or receive information 405 corresponds to the network access ports 504 used by the server 500 to communicate with the network 507, the logic configured to process information 410 corresponds to the processor 501, and the logic configuration to store information 415 corresponds to any combination of the volatile memory 502, the disk drive 503 and/or the disc drive 506. The optional logic configured to present information 420 and the optional logic configured to receive local user input 425 are not shown explicitly in FIG. 5 and may or may not be included therein. Thus, FIG. 5 helps to demonstrate that the communication device 400 may be implemented as a server, in addition to a UE implementation as in 305A or 305B as in FIG. 3.

UEs may occasionally lose network service, or connectivity, with the RAN (e.g., RAN 120) or another access point (e.g., access point 125), such as when the UE is in an underground subway system, in an elevator, going through a tunnel, or the like. When the UE regains connectivity, it assumes that all of the network connections between itself and the server (e.g., application server 170) recovered correctly. However, that is not always the case, and the UE may not discover the problem until the user attempts to make a call, or the UE attempts to perform some other network interaction. At that time, the UE may have to re-register with the network, causing a delay.

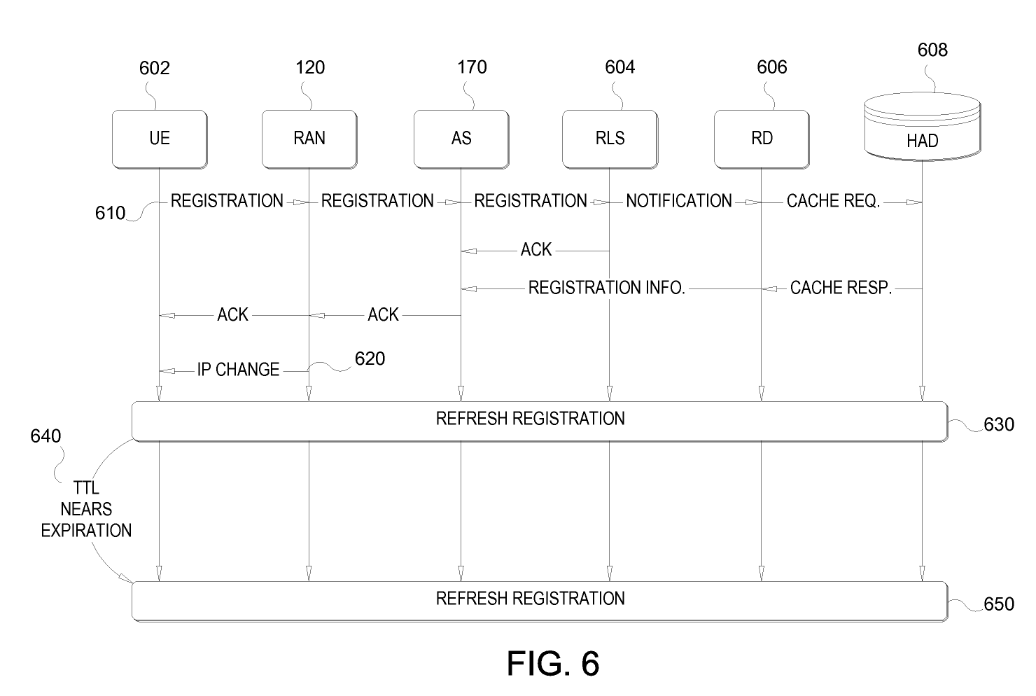

FIG. 6 illustrates a high-level flow of a conventional registration sequence. At 610, a UE 602 sends a registration request to the application server 170 via the RAN 120. The application server 170 sends the registration request for the UE 602 to a resource list subscription (RLS) 604. The RLS 604 responds to the registration request from the application server 170 with an acknowledgment (ACK). The request may be a session initiation protocol (SIP) registration request message and the acknowledgment may be an SIP 200 “OK” message. The RLS 604 sends a notification to a regional dispatcher (RD) 606, which makes a cache request to a home address dictionary (HAD) 608. The HAD 608 sends a cache response to the RD 606, which forwards the registration information to the application server 170. The application server 170 sends an acknowledgment to the UE 602, via the RAN 120, notifying the UE 602 that it is now registered.

The RD 606 tracks the registration status for individual subscribers and performs the actual call setup. The HAD 608 caches the registration status and capabilities for all users of a given carrier. The RLS 604 and RD 606 are “regional,” in that they are limited to a particular geographic area to help with load and scaling, while the HAD 608 is shared by all regions. There may be many regions in a carrier network, and thus many RLS' 604 and RDs 606, but there is only one HAD 608. The RLS 604 and the RD 606 may be components of the application server 170, or separate entities. Alternatively, the application server 170 may be a component of the RD 606.

At 620, the RAN 120 may change the IP address of the UE 602, requiring the UE 602 to register with the application server 170 again. Accordingly, at 630, the UE 602 refreshes its registration, which requires the UE 602, the RAN 120, the application server 170, the RLS 604, the RD 606, and the HAD 608 to perform the same steps as for the initial registration at 610.

At 640, the UE 602's time-to-live (TTL) timer nears its expiration. Accordingly, at 650, the UE 602's registration is again refreshed, which again requires the UE 602, the RAN 120, the application server 170, the RLS 604, the RD 606, and the HAD 608 to perform the same steps as for the initial registration at 610.

The disclosure provides a mechanism to detect, report, and recover from potential service disruptions. The UE can track frequent or extended serving system outages (i.e., loss of connectivity) and “ping” the application server 170 when it recovers connectivity. By pinging the application server 170, the UE verifies that it still has a connection all the way through to the application server 170.

The ping is sent directly to the RD to check connectivity through to the application server 170 when the UE predicts that it might have a connectivity issue. The UE can resend the ping multiple times, potentially informing the user through the service annunciator that it may not have connectivity. After several failures to receive a response to the pings, the UE can undergo the full registration cycle starting with the DNS.

The ping does not need to be automatic after each network “glitch.” Rather, a tunable algorithm can be used to find the right balance between the likelihood of a connectivity issue and the frequency of pinging. For example, the algorithm may provide that the UE should not ping the application server 170 unless it loses connectivity for more than five minutes.

One case where such a tunable algorithm may be useful is where the UE's connectivity is fine, but the RD 606 is down or loaded. In that case, instead of performing a full registration sequence, the UE can try to use the next dedicated channel (DCH) IP address. A DCH is assigned to a single UE, as opposed to a channel that is shared by multiple UEs. Typically, the UE receives a list of IP addresses after the DNS lookup and the first DCH IP address is used to send call requests.

To further increase the fault tolerance, a loaded DCH can redirect the UE to an available DCH. For example, the UE may send a call request to a first DCH that is loaded and cannot admit further calls. Instead of rejecting the call outright, the first DCH can direct the UE to send the call request to a second DCH by, for example, including the IP address of the second DCH in the response.

Note that a loss of service/connectivity is not the same as the UE switching networks. When the UE switches networks, it will receive a new IP address, which will trigger a new registration, making the ping irrelevant.

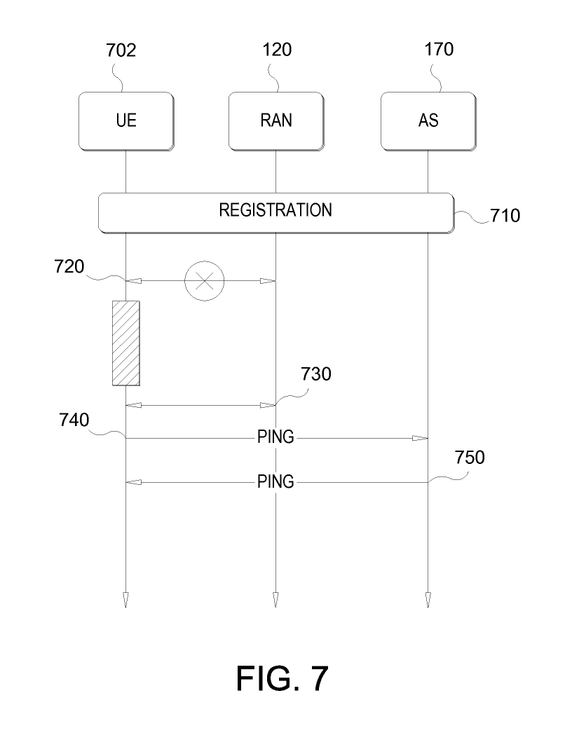

FIG. 7 illustrates an exemplary flow for detecting potential service disruptions at a UE. At 710, the UE 702 registers with the application server 170, as illustrated at 610 of FIG. 6. At 720, the UE 702 loses connectivity with the RAN 120. The UE 702 may lose connectivity due to, for example, being in an underground subway system, in an elevator, going through a tunnel, or the like. At 730, the UE 702 regains connectivity to the RAN 120.

At 740, the UE 702 pings the application server 170 to verify that it still has a connection all the way through to the application server 170. If the ping reaches the application server 170, the application server 170 will respond at 750.

If the application server 170 does not respond to the ping, the UE 702 may check its data connection and send a second ping. If the application server 170 still does not respond, the UE 702 may attempt to identify other connection failure points and send additional pings up to a certain number before declaring a connection failure and undergoing a new registration process.

In this way, the UE 702 can identify and potentially correct a connection issue after regaining connectivity.

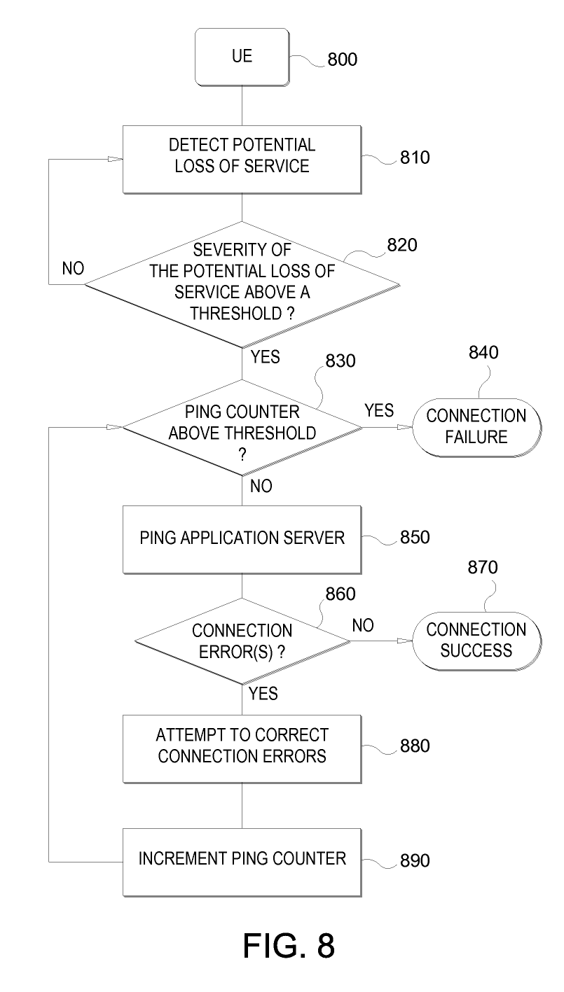

FIG. 8 illustrates an exemplary flow for detecting potential service disruptions performed at a UE 800. At 810, the UE 800 detects the loss, or potential loss, of network service. Specifically, the UE 800 detects events that are known to potentially disrupt service, such as a reduction in signal strength, a service fade, loss of digital service, or a change in IP address. An actual disruption may or may not have actually occurred, and as such, a recovery of network service may or may not occur either.

At 820, the UE 800 determines whether or not the severity of the potential loss of service is above a severity threshold. This may include counting the duration of the potential disruption and/or balancing the severity of different types of potentially disruptive events. For example, a signal fade for five seconds may be less than the severity threshold, while three fades in a row might be above the severity threshold. As another example, a loss of digital service for 10 seconds might be less than the severity threshold, while a loss of digital service for two minutes might be above the severity threshold.

If at 820 the UE 800 determines that the severity of the potential loss of service is below the threshold, the UE 800 does not transmit, or blocks transmission of, a ping to the application server 170, and the flow returns to 810. However, if the potential loss of service is above the threshold, then at 830, the UE 800 determines whether or not a ping counter is above a threshold. If it is, then at 840, the UE 800 determines that there is a connection failure. The UE 800 then resets the ping counter.

If the ping counter is not above the threshold, however, then at 850, the UE 800 pings the application server 170. At 860, the UE 800 determines whether or not there are connection errors, which it determines based on whether or not it receives a response to the ping. If the UE 800 receives a response to the ping, then there are no connection errors, and at 870, the UE 800 determines that it is successfully connected through to the application server 170.

If, however, the UE 800 does not receive a response to the ping, then at 880, the UE 800 attempts to correct the connection error(s). At 890, the UE 800 increments the ping counter and returns to 830, where it will send another ping to the application server 170 if the ping counter has not reached the maximum ping threshold. The number and frequency of the pings the UE 800 sends to the application server 170 can be based on a number of factors, such as the number of possible connection errors the UE 800 can correct, the priority of the UE 800, the battery level of the UE 800, the time of day (e.g., peak or off-peak), and/or the like.

When a UE loses service/connectivity temporarily, its status on the network still shows that it is registered, and thus connected and available. However, if a caller calls the UE during this time, the call will not go through. This can be frustrating and confusing for the caller. Accordingly, it would be beneficial if the application server 170 could update the UE's status to indicate that it is likely unreachable when the UE has lost service, thus providing an improved user experience for the caller.

The application server 170 can track failed calls to a specific UE. If a certain number of failures occur within a given timeframe, the application server 170 can start actively pinging the UE for a period of time after the failure, for example, up to the SIP TTL expiration. Additionally, the application server 170 can keep track of activity associated with the UE, such as registration, call initiation, acknowledgements, and/or the like. The ping schedule can thus be altered based on the UE's activity.

The application server 170 can make a determination that after enough failed call attempts and/or ping attempts, the UE's state in the HAD cache can be marked as “gone.” Currently, there are two states for a UE in the HAD cache, “registered” and “not registered.” “Gone” is a less certain state that means the user is likely not reachable. When a UE is “gone,” the application server 170 can report back to the caller that the user is gone, but still make an attempt to connect a call request in case the UE regains connectivity in time to receive the call.

Additionally, the ping mechanism can be piggybacked for use in the availability notification (AN) and presence-on-demand (POD) scenarios, in which the user is deemed “gone” if a POD or AN request for that UE is initiated by other users. Both a POD and an AN request appear as separate call setup transactions between the UE and the application server 170. Since there is already a ping going to the application server 170, the POD or AN request can be piggybacked on the ping, rather than having to complete the call setup for the POD or AN request.

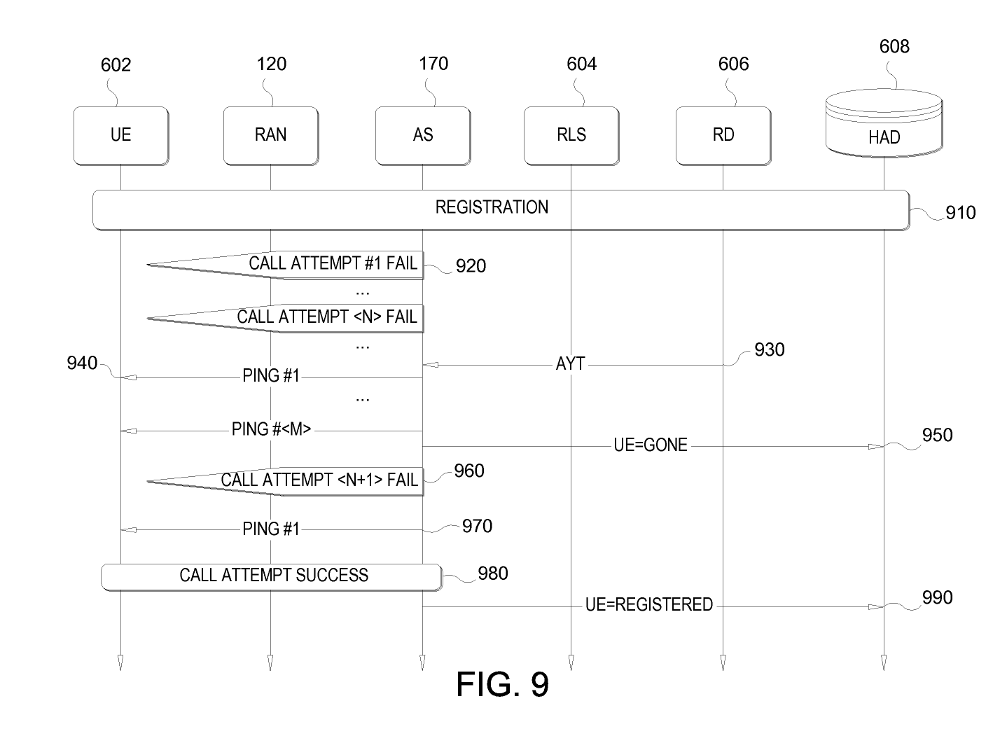

FIG. 9 illustrates an exemplary flow of actions the application server 170 can perform to regain a connection to a UE 902. At 910, the UE 902 registers with the application server 170, as illustrated at 610 of FIG. 6. At 920, the application server 170 makes a series of N failed call attempts to the UE 902. The call attempts may be, but need not be, all from the same caller.

The RD 606 receives the call attempts from the caller via the RAN 120. As discussed above, the RD 606 may be a component of the application server 170, or vice versa, or they may be separate entities. After N failed call attempts, the RD 606 determines that the UE 902 may not be reachable. Accordingly, at 930, the RD 606 sends an are-you-there (AYT) message to the application server 170. In response, the Application server 170 begins sending a series of M pings to the UE 902 at 940. If the UE 902 does not respond to the M pings, the application server 170 determines that the UE 902 is not reachable, and at 950, the application server 170 updates the UE 902's status at the HAD 608 to “gone.”

The application server 170 may send pings to the UE 902 up to the SIP TTL expiration. Alternatively or additionally, the number and/or frequency of the pings can be based on the importance of the UE 902 and/or the caller. For example, the application server 170 may send more pings to the UE 902 if it is receiving a larger number of incoming calls for the UE 902, if there have been a larger number of failed calls to the UE 902, if the caller(s) is/are high priority user(s), if the UE 902 belongs to a high priority user, if there is sufficient network capacity in the sector in which the UE 902 was last known to be located, if it is during an off-peak time of day, and/or the like.

At 960, the application server 170 makes another failed call attempt to the UE 902. The caller may see that the UE 902 is likely not reachable, or “gone,” but decide to call anyway. Since the status of the UE 902 is “gone,” the application server pings the UE 902 at 970. If the call connects at 980 despite the UE 902's status being “gone,” then at 990, the application server 170 updates the UE 902's status at the HAD 608 to “registered.”

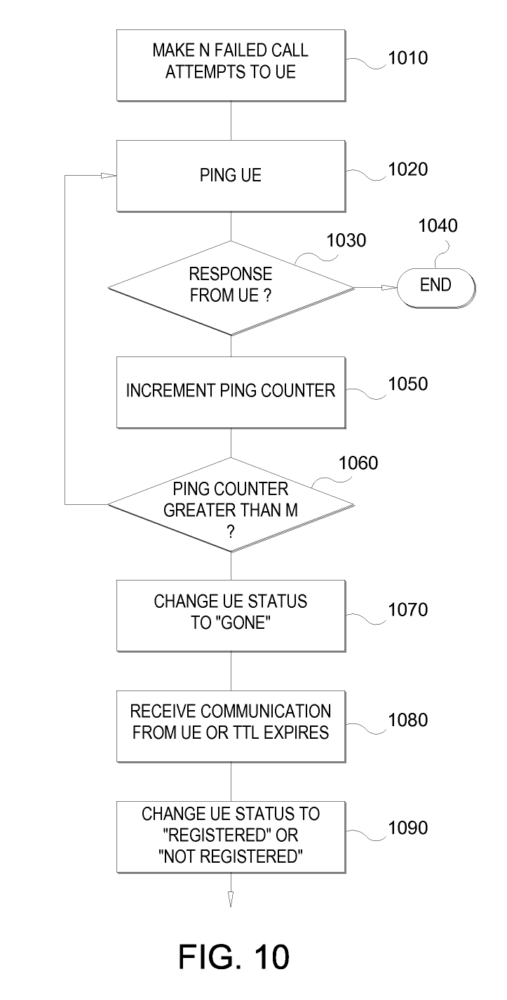

FIG. 10 illustrates an exemplary flow for detecting potential service disruptions affecting a UE. The flow illustrated in FIG. 10 can be performed by the application server 170. At 1010, the application server 170 makes N failed call attempts to a particular UE, as at 920 of FIG. 9. The N call attempts should be consecutive and occur close enough together in time that their failure indicates that the UE may not have service/connectivity. For example, three consecutive failed call attempts in half an hour may indicate that the UE does not have connectivity, whereas three non-consecutive failed call attempts over two days would likely not.

At 1020, the application server 170 pings the UE, as at 940 of FIG. 9. At 1030, the application server 170 determines whether or not it has received a reply to the ping from the UE. If it has, then the UE has connectivity and the flow ends at 1040. If, however, the UE does not respond to the ping, then at 1050, the application server 170 increments a ping counter. At 1060, the application server 170 determines whether or not the ping counter is greater than a threshold M. If it is not, then the flow returns to 1020 and the application server 170 pings the UE again. If it is, however, then at 1070, the application server 170 changes the status of the UE from “registered” to “gone,” as at 950 of FIG. 9, indicating that the UE is likely not reachable.

The number and frequency of the pings can depend on the importance of the UE and/or the caller, as discussed above. The greater the importance of the UE and/or the caller, the more pings the application server 170 may send and the more frequently it may send them.

By changing the status of a likely unreachable UE to “gone,” or some other similar status indicator, the application server 170 can provide a richer user experience for users calling the likely unreachable UE. For example, knowing that the user they are calling is likely unreachable, callers will not be as frustrated or confused when they cannot reach that user.

At 1080, the application server 170 detects some activity from the UE, indicating that it is connected to the network (again). Alternatively, the TTL timer for the UE may expire before any communication is received from the UE. At 1090, if the application server 170 detected some activity from the UE, it changes the status of the UE from “gone” back to “registered.” However, if the registration TTL timer has expired, the application server 170 changes the status of the UE from “gone” to “not registered.”

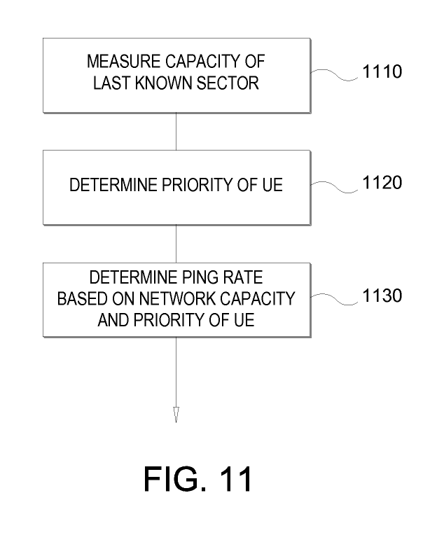

FIG. 11 illustrates an exemplary flow for determining the rate at which the application server 170 may ping the UE. At 1110, the application server 170 measures the capacity in the last known sector in which the UE was located. This can include a consideration of the time of day, such as whether or not the application server 170 will be pinging the UE during peak or off-peak time. At 1120, the application server 170 determines the priority of the UE, which may be based on the priority of the user of the UE, the number of incoming calls to the UE, the priority of the incoming calls and/or callers, the number of failed calls to the UE, and/or the like.

At 1130, the application server 170 determines the ping rate based on the capacity of the network and the priority of the UE. The higher the capacity of the network and/or the priority of the UE, the more frequently the application server 170 will ping the UE. Conversely, the lower the network capacity and/or the priority of the UE, the less frequently the application server 170 will ping the UE.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method for detecting a potential loss of network service performed by a user equipment (UE), comprising:
detecting a change in one or more criteria, the change in the one or more criteria indicating a potential loss of network service;
determining whether or not a severity of the potential loss of network service is above a severity threshold based on the change in the one or more criteria;
transmitting a ping to a server to which the UE was connected before detecting the potential loss of network service based on the severity of the potential loss of network service being above the severity threshold; and
blocking transmission of a ping to the server to which the UE was connected before detecting the potential loss of network service based on the severity of the potential loss of network service not being above the severity threshold.

2. The method of claim 1, wherein the one or more criteria include one or more of a signal strength, a service fade, a loss of digital service, or a change in Internet protocol (IP) address.

3. The method of claim 1, wherein the determining comprises determining whether or not the severity of the potential loss of network service is above the severity threshold based on a duration of the potential loss of network service being longer than a threshold and/or a value of at least one of the one or more criteria being above a threshold.

4. The method of claim 1, further comprising:
determining whether or not there is a network connection error based on the severity of the potential loss of network service being above the severity threshold;
attempting to correct the network connection error based on there being a network connection error; and
transmitting a ping to the server after attempting to correct the network connection error.

5. The method of claim 4, wherein the UE transmits a ping to the server up to a threshold number of times before determining that the network connection has failed.

6. The method of claim 5, further comprising performing a new registration with an available network based on determining that the network connection has failed.

7. The method of claim 1, wherein the transmitting the ping to the server comprises:
determining whether or not a ping counter is above a threshold before transmitting the ping to the server; and
transmitting the ping to the server based on the ping counter not being above the threshold.

8. The method of claim 7, further comprising:
determining that the UE has lost network service based on the ping counter being above the threshold.

9. A method for regaining a connection to a user equipment (UE) performed by a server, comprising:
attempting unsuccessfully to connect one or more received call requests to the UE;
transmitting one or more pings to the UE; and
changing a presence status of the UE to indicate that the UE is likely not reachable based on not receiving a response to the one or more pings from the UE before the server transmits a threshold number of pings to the UE.

10. The method of claim 9, wherein the one or more received call requests comprises consecutive call requests within a threshold period of time.

11. The method of claim 9, wherein the one or more received call requests comprise a single call request from a high priority user.

12. The method of claim 9, further comprising:
ceasing transmission of the one or more pings based on receiving a response to the one or more pings from the UE before the server transmits the threshold number of pings to the UE.

13. The method of claim 9, further comprising:
receiving a call request after changing the presence status of the UE to indicate that the UE is likely not reachable.

14. The method of claim 13, further comprising:
attempting unsuccessfully to connect the received call request to the UE;
transmitting one or more pings to the UE; and
completing the received call request to the UE.

15. The method of claim 14, further comprising:
updating the presence status of the UE to indicate that the UE is reachable in response to completing the received call request.

16. The method of claim 9, further comprising:
determining a rate at which to transmit the one or more pings to the UE.

17. The method of claim 16, further comprising:
measuring a capacity in a last known sector in which the UE was located, wherein the determined rate is based on the measured capacity.

18. The method of claim 16, further comprising:
determining a priority of the UE, wherein the determined rate is based on the determined priority.

19. The method of claim 18, wherein the priority of the UE is based on a number of one or more incoming calls to the UE, a priority of one or more callers of the one or more incoming calls, a priority of a user of the UE, and/or a number of failed calls to the UE.

20. An apparatus for detecting a potential loss of network service performed by a user equipment (UE), comprising:
logic configured to detect a change in one or more criteria, the change in the one or more criteria indicating a potential loss of network service;
logic configured to determine whether or not a severity of the potential loss of network service is above a severity threshold based on the change in the one or more criteria;
logic configured to transmit a ping to a server to which the UE was connected before detecting the potential loss of network service based on the severity of the potential loss of network service being above the severity threshold; and
logic configured to block transmission of a ping to the server to which the UE was connected before detecting the potential loss of network service based on the severity of the potential loss of network service not being above the severity threshold.

21. The apparatus of claim 20, wherein the one or more criteria include one or more of a signal strength, a service fade, a loss of digital service, or a change in Internet protocol (IP) address.

22. The apparatus of claim 20, wherein the logic configured to determine comprises logic configured to determine whether or not the severity of the potential loss of network service is above the severity threshold based on a duration of the potential loss of network service being longer than a threshold and/or a value of at least one of the one or more criteria being above a threshold.

23. The apparatus of claim 20, further comprising:
logic configured to determine whether or not there is a network connection error based on the severity of the potential loss of network service being above the severity threshold;
logic configured to attempt to correct the network connection error based on there being a network connection error; and
logic configured to transmit a ping to the server after attempting to correct the network connection error.

24. The apparatus of claim 23, wherein the UE transmits a ping to the server up to a threshold number of times before determining that the network connection has failed.

25. The apparatus of claim 24, further comprising performing a new registration with an available network based on determining that the network connection has failed.

26. An apparatus for regaining a connection to a user equipment (UE) performed by a server, comprising:
logic configured to attempt unsuccessfully to connect one or more received call requests to the UE;
logic configured to transmit one or more pings to the UE; and
logic configured to change a presence status of the UE to indicate that the UE is likely not reachable based on not receiving a response to the one or more pings from the UE before the server transmits a threshold number of pings to the UE.

27. The apparatus of claim 26, further comprising:
logic configured to cease transmission of the one or more pings based on receiving a response to the one or more pings from the UE before the server transmits the threshold number of pings to the UE.

28. The apparatus of claim 26, further comprising:
logic configured to receive a call request after changing the presence status of the UE to indicate that the UE is likely not reachable.

29. The apparatus of claim 28, further comprising:
logic configured to attempt unsuccessfully to connect the received call request to the UE;
logic configured to transmit one or more pings to the UE; and
logic configured to complete the received call request to the UE.

30. The apparatus of claim 29, further comprising:
logic configured to update the presence status of the UE to indicate that the UE is reachable in response to completing the received call request.
